(19) United States
(12) Patent Application Publication
(10) Pub. No.: US 2009/0092441 A1
(43) Pub. Date: Apr. 9, 2009

(54) APPARATUS FOR MOVABLY SECURING A DEVICE TO A SUPPORT

(76) Inventors: Austin Everett Unsworth, Fort Mill, SC (US); Gary DeCarr, Charlotte, NC (US); Nathan Hemmer, Rock Hill, SC (US)

Correspondence Address: TRASKBRITT P.C., P.O. Box 2550, Salt Lake City, UT, 84110, US

(21) Appl. No.: 11/867,614

(22) Filed: Oct. 4, 2007

(51) Int. Cl. F16M 13/00; F16C 11/00

(52) U.S. Cl. 403/92; 248/424

(57) ABSTRACT

An apparatus is provided that may be used to movably connect a device to a support. The apparatus may be a mechanical arm with multiple connections that allows the device to move into various positions and orientations. The connections may include a coupling attached to a connection assembly that movably secures the coupling to an elongated member. Each of the connection assemblies may provide a pivot point which allows rotation upon a sufficient force and provide a mechanism for removably securing a coupling at desired increments. The device may be an instrument or fixture for dental or medical use, such as an operating room light, a dental examination light, a liquid crystal display (LCD), a mirror, delivery head, etc. The support may be attached to a surface such as a ceiling or floor.

### FIELD OF THE INVENTION

The present invention relates to an apparatus that connects a device to a support, and more particularly, to a mechanical arm with multiple connections that allow the device to move into various positions and orientations.

### BACKGROUND OF THE RELATED ART

Mechanical support arms utilizing four bar linkage assemblies are utilized in a variety of settings. Such arms are typically used to support loads at adjustable locations. For example, in a dental office or operatory setting, instruments, devices and fixtures may be supported by a mechanical, or “flex,” arm within reach of the practitioner. The arm typically includes a brake mechanism for locking the load in a selected position. When the brake is released, the load-bearing end of the arm may be raised or lowered as desired. The load-bearing end typically supports a fixture which maintains a selected level with respect to vertical and horizontal reference planes.

In a typical arrangement, an elongated arm member is pivotally fastened at a first end to an end post. The end post may be fixed or movable, but in any case comprises an anchor for the mechanical arm. A second end of the arm is pivotally fastened to a support post, which comprises a connection mechanism for a positionable load. The pivot axis of the arm member at the end post is ordinarily horizontally disposed so that the load-bearing end can be moved up or down vertically. A mechanism may also be provided to permit the arm to pivot around a vertical axis at the end post. The pivot axis of the arm member at the support post is also typically disposed in a general horizontal configuration. The head fixture is typically connected through a mechanism providing for pivoting around an approximately vertical axis at the support post.

Conventional four-bar assemblies used in dental and operatory flex arms are mechanically complex, yet do not allow for a broad range of movement. Moreover, they are often difficult to disassemble in the field for maintenance. It is generally impractical for a clinician to effect adjustments of spring tension and leveling. Accordingly, there is a need in the art for an improved mechanical arm assembly for use in dental and medical operatories as well as other environments.

### BRIEF SUMMARY OF THE INVENTION

One aspect of the invention includes an apparatus that may be used to movably connect a device to a support. The apparatus may be a mechanical arm with multiple connections that allows the device to move into various positions and orientations. The connections may include a coupling attached to a connection assembly that movably secures a coupling to an elongated member. The device may be an instrument or fixture for dental or medical use, such as an operating room light, a dental examination light, a liquid crystal display (LCD), delivery head, a mirror, etc. The support may be attached to a surface such as a ceiling, floor, chair, wall, or cabinet.

Another aspect of the invention is an apparatus that includes at least two connection assemblies. The connection assemblies may be removably attached and allow the position and orientation of the apparatus to be easily adjusted. Each of the connection assemblies may provide a pivot point which allows rotation through use of sufficient force and provide a mechanism for removably securing a coupling at desired increments. For example, the connection assembly may allow the coupling to be rotated at increments of fifteen (15) degrees. Thus, the pivotal connection allows the apparatus to be moved between positions. The pivotal connection also allows the height of the device to be readily adjusted.

In a further aspect, the apparatus includes couplings movably attached to connection assemblies offset on a single side of an elongated arm. The connection assemblies allow the couplings to be removed and attached at a different orientation. Because the pivot points are provided on the side of the assembly rather than on the top and bottom, the mounting configuration of the assembly can be easily changed without redesign.

In yet another aspect, the apparatus may be a mechanical arm including an elongated member with a body and a cover that may be removably connected by at least one fastener, such as a bolt. The elongated member may include a gasket disposed between the body and the cover. The two-piece design allows for adjustment of internal mechanisms, such as connecting mechanism, biasing mechanisms, conduits or power sources. The two-piece design also forms a passage through the arm that permits tubing and wires to be passed therethrough, which acts to conceal tubing and wires in the arm.

### BRIEF DESCRIPTION OF THE SEVERAL VIEWS OF THE DRAWINGS

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIGS. 1 and 2 are perspective views of an apparatus according to an embodiment of the invention;

FIG. 3 is a side view of the apparatus shown in FIGS. 1 and 2;

FIG. 4 is an exploded perspective view of a connection assembly incorporated with an apparatus according to an embodiment of the invention;

FIGS. 5 and 6 are side views of the apparatus according to embodiments of the invention; and

FIG. 7 is a perspective view of a portion of the apparatus shown in FIGS. 5 and 6, illustrating the elongated member.

### DETAILED DESCRIPTION OF THE INVENTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination.

Reference will now be made to the drawings. Like elements are identified by like numerals. The drawings are not necessarily to scale.

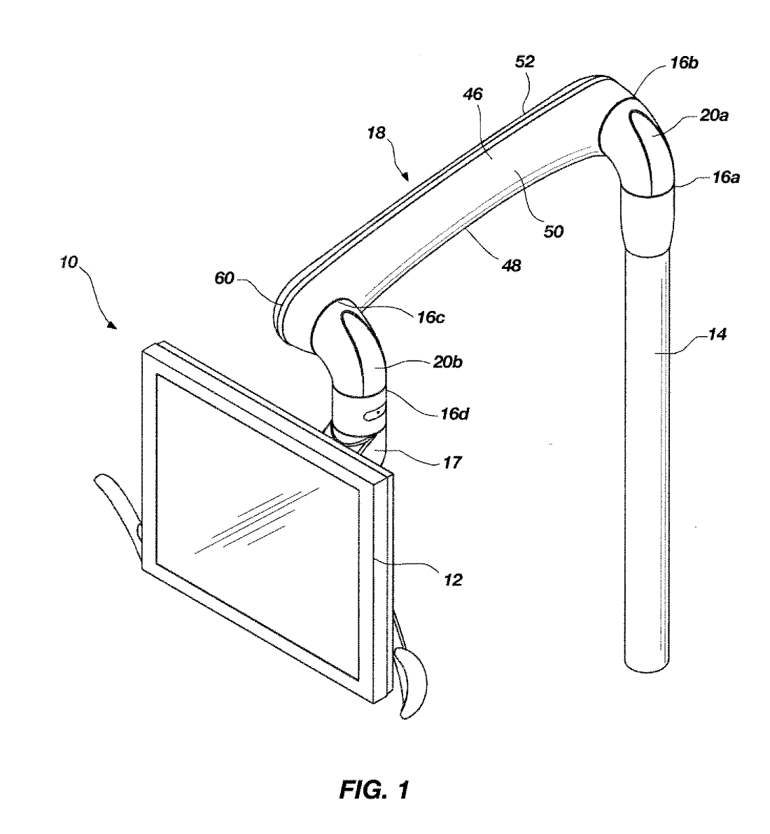

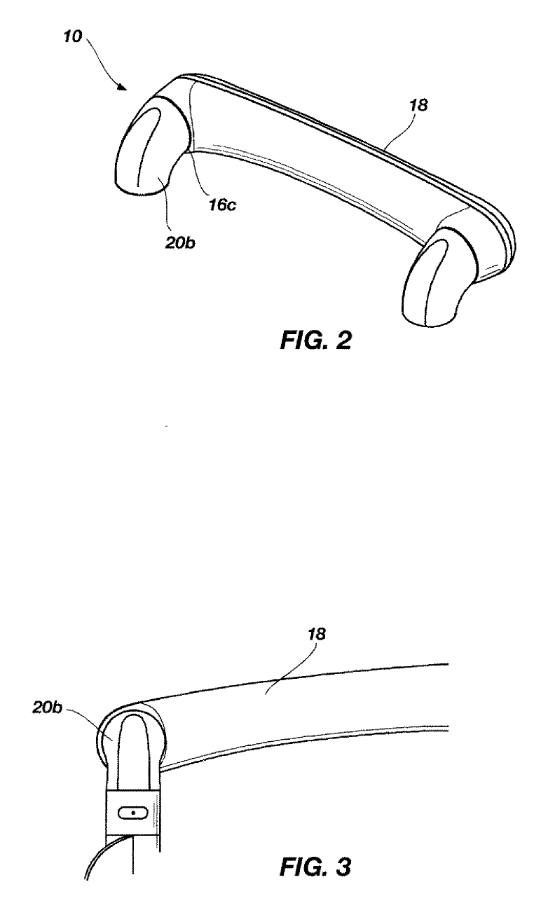

As illustrated in FIGS. 1 and 2, an apparatus 10 may be used to connect a device 12 to a support 14. The apparatus 10 may be, for example, a mechanical arm with multiple connections 16 that allow the movement of the device into various positions and orientations. Each of the connections 16a, 16b, 16c, and 16d may provide a pivot point to allow rotation. The apparatus 10 may include an elongated member 18 movably connected to the device 12 and the support 14 by couplings 20a and 20b. The couplings 20a and 20b may be movably secured to the elongated member 18 by internal connection assemblies (not shown) that allow the couplings 20a and 20b to be adjusted in various rotational orientations. The couplings 20a and 20b may be disposed proximate the ends of the elongated member 18, such that the positioning of the apparatus 10 may be readily adjusted to control the height and orientation of the device 12. Although the couplings 20a and 20b are shown as being mounted on the same side of elongated member 18, in an alternative embodiment (not shown), the couplings 20a and 20b can be mounted on opposite sides (sides 50 and 52) of the elongated member 18. The device 12 may be attached to the apparatus 10 via a bracket 17, or other similarly functioning attachment.

The support 14 may be used to support the assembly 10 and to secure the assembly 10 to a stationary point. The support 14 may be, for example, a post that may be mounted to a surface, such as the ceiling or floor, chair, wall, or cabinet. The support 14 may be pivotally connected to the coupling 20a at a connection 16a to allow the apparatus 10 to rotate about the support 14. In some embodiments, the support 14 may be movably or pivotally attached to an opening in the coupling 20a to allow the apparatus 10 to rotate to a desired configuration. For example, the support 14 may be received within the opening by interference or friction fit to attach the support 14 to the coupling 20a, as shown in FIG. 3.

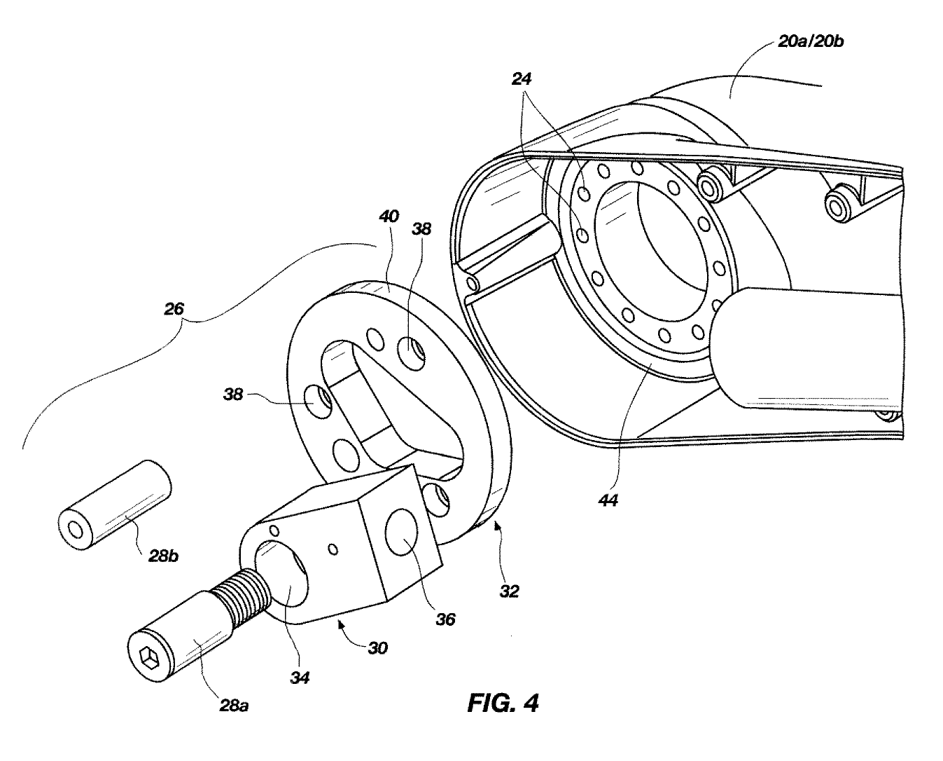

The coupling 20a may have a generally L-shaped or angled configuration forming an angle of about ninety (90) degrees, or may alternatively have any other desired angle and suitable shape. For example, the coupling 20a may have a tubular elbow shape such as that shown in FIGS. 1 and 2. The coupling 20a may be removably secured to the support 14 such that the positioning and orientation of the apparatus 10 may be adjusted. As shown in FIG. 3, the coupling 20a may include an end portion 22 with a plurality of threaded openings 24 that allow the coupling 20a to be movably connected to the support 14 or the elongated member 18 via a connection assembly 26, such as that shown in FIG. 4 and described in detail below. By way of non-limiting example, the threaded openings 24 may be spaced at suitable increments, such as 15 degree increments, so that the coupling 20a may be rotated. The rotation of coupling 20a about allows the apparatus 10 to be used to mount the apparatus in an upwards direction (e.g., from the floor) or a downward direction (e.g., from the ceiling). For example, the coupling 20a may be rotated one hundred eighty (180) degrees to change the orientation of the device 12.

The connection assembly 26 may be used to movably secure the coupling 20a to the elongated member 18 by a friction or interference fit. As a non-limiting example, the first connection assembly 26 may include a fasteners 28a and 28b, a block 30, a capture plate 32 and bushings (not shown), each of which is configured to form a stacked assembly. The block 30 may include an aperture 34 through which the fastener 28a may be inserted as well as an attachment point 36 for attaching a biasing member, such as a spring. The block 30 may be formed from a metal, such as steel, or any other suitable material. The capture plate 32 includes apertures 38 that extend through the capture plate 32 and align with threaded openings 24 in the coupling 20a. The capture plate 32 may be formed from a metal, such as aluminum, or any other suitable material. The bushing (not shown) is configured to surround the perimeter 40 and a contact surface 42 of the capture plate 32. The connection assembly 26 may form a pivot point which allows rotation of the coupling 20a about the elongated member 18. The connection assembly 26 allows the coupling 20a to be movably connected to the elongated member 18. The fastener 28a may be inserted through the aperture 34 in the block 30 and a selected aperture 38 in the plate 32, and may be removably secured to the coupling 20a via a threaded opening 24. The bushings (not shown) substantially reduce wear and friction on the plate 32, the coupling 20a and the internal surface 44 of the elongated member 18 while further restraining the motion of the connection assembly 26. The compression of the connection assembly 26 against the internal surface 44 of the elongated member 18 allows coupling to be selectively moveable upon application of pressure sufficient to overcome the frictional forces.

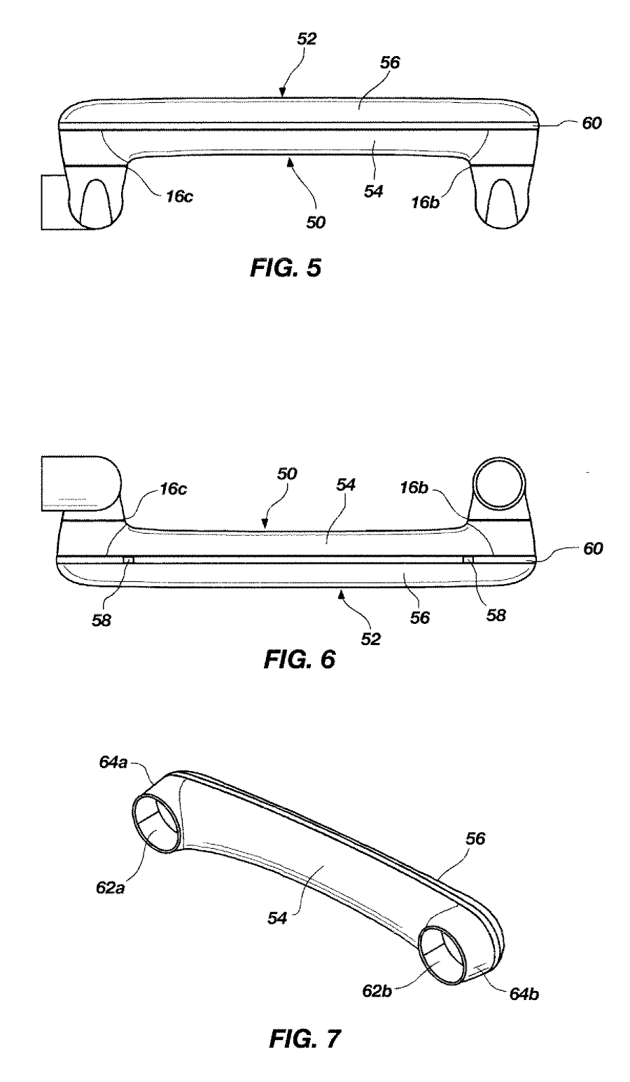

Referring to FIGS. 1, 5, and 6, the elongated member 18 may include a top 46, a bottom 48, a side 50 and an opposite side 52, and the elongated member 18 may include connections 16b and 16b disposed on at least one side. The elongated member 18 may have a generally curved or arched configuration. The elongated member 18 may include a body 54 and a cover 56 that are removably connected, as shown in FIGS. 5 and 6. The body 54 and the cover 56 may be connected, for example, by fasteners 58, such as bolts or screws, that may be located on the bottom 48 and proximate the ends of the elongated member 18, as shown in FIG. 6. A gasket 60 may be disposed between the body 54 and the cover 56. The body 54 and the cover 56 are made from a rigid material, such as a metal. As a non-limiting example, the body 54 and cover 56 may be formed from aluminum or steel. The body 54 and cover 56 may be contoured so as to form a housing when attached. Both the body 54 and the cover 56 may be integrally formed as a unitary, one-piece structure using, for example, die-casting, extrusion or another suitable process. As a non-limiting example, the gasket 60 may be made of a flexible material, such as plastic or rubber.

As shown in FIG. 7, the elongated member 18 includes at least two orifices 62a and 62b that are disposed proximate the ends 64a and 64b of the body 54, such that the positioning of the apparatus 10 may be adjusted. The orifices 62a and 62b may be integrally formed in the body 54 of the elongated member 18 during the extruding process to form a unitary structure, or may be bored out of the body 54 after formation. The orifices 62a and 62b are aligned generally parallel to one another, and may be configured to selectively receive the ends 22 of couplings 20a and 20b, as shown in FIG. 4.

The elongated member 18 may form part of a housing that may contain, for example, a power source, a conduit, connection assemblies, or any type of biasing member, such as a spring or piston. The body 54 and the cover 56 may be detached from one another to allow, for example, the connection to be adjusted or to move the biasing member to a desired position. For example, the elongated member 18 may include a counterbalance spring to facilitate adjustment of the apparatus 10. The counterbalance spring may be positioned such that it provides support for the device at a desired height while providing fluid up and down motion. The counterbalance spring may consist of a spring attached within the elongated member 18. The counterbalance spring provides a force which substantially counterbalances the gravitational force acting on the apparatus 10. The counterbalance spring may include a first end attached to a movable point and a second end attached to a vertical fixed point. For example, the first end of the counterbalance spring may be attached to the block 30 or the plate 32 of the connection assemblies 26 and a second end of the counterbalance spring may be attached to a fixed point, such as a squaring arm (not shown), within the elongated member 18. One skilled in the art will appreciate that other suitable counterbalances could also be used in connection with the apparatus 10.

A connection assembly 26 may be used to movably attach the second elongated member 18 to another coupling 26b. The connection assembly 26 may include fasteners 28a and 28b, a block 30, a capture plate 32 and bushings (not shown), each of which is configured to form a stacked assembly, as described above and illustrated in FIG. 4. The connection assembly 26 may form a pivot point which allows rotation about the elongated member 18. The connection assembly 26 allows the coupling 20b to be movably connected to the elongated member 18. The fastener 28a may be inserted through the aperture 34 in the block 30 and an aperture 38 in the capture plate 32 and may be removably secured to the coupling 20b via a threaded opening 24. The fastener 28b may be inserted through an aperture 38 in the capture plate 32 and the aligned threaded opening 24 in the coupling 20b. The bushings (not shown) substantially reduce wear and friction on the capture plate 32, the coupling 20b and the internal surface 44 of the elongated member 18 while further restraining the motion of the another connection assembly 26. The compression of the connection assembly 26 against the internal surface 44 of the body 54 of the elongated member 18 allows coupling to be selectively moveable upon application of pressure sufficient to overcome the frictional forces.

The coupling 20b may have a generally L-shaped or angled configuration forming an angle of about ninety (90) degrees, or have may any other desired angle and suitable shape. For example, the coupling 20b may have a tubular elbow shape such as that shown in FIGS. 1 and 2. The coupling 20b may be removably secured to the bracket 17 such that the positioning and orientation of the apparatus 10 may be adjusted. As shown in FIG. 4, the coupling 20b may include an end portion 22 with a plurality of threaded openings 24 that allow the coupling 20b to be movably connected to the elongated member 18 or the bracket 17 via another connection assembly 26. For example, the threaded openings 24 may be spaced at fifteen degree (15) degree increments such that another coupling 20b may be rotated. The rotation of another coupling 20b allows the apparatus to be used to mount the apparatus in an upwards direction or a downward direction. For example, another coupling 20b may be rotated one hundred eighty (180) degrees to change the orientation of the apparatus 10, and thus, the orientation of the device 12.

The bracket 17 may be attached to the apparatus 10 by another coupling 26 attached by a snap, interference or friction fit. The bracket 17 may include one or more connecting members such as flanges (not shown), that allow the bracket 17 to be connected to the device 12, as shown in FIG. 1.

Thus, the apparatus 10 may be used in a variety of applications in a dental or operatory setting. Because the apparatus 10 includes multiple pivotal connections offset on at least one side as well as adjustable connections, the orientation of the apparatus may be easily reversed.

Although the foregoing description contains many specifics, these are not to be construed as limiting the scope of the present invention, but merely as providing certain representative embodiments. Similarly, other embodiments of the invention can be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

1. An apparatus for movably attaching a device to a support, comprising:
an elongated member configured to connect a device to a support;
an elbow-shaped coupling removably secured in a substantially horizontal position between the elongated arm and the device, the coupling providing pivotal movement in a substantially vertical plane and configured to be rotated through a variety of orientations in a substantially horizontal plane; and
a second elbow-shaped coupling removably secured in a substantially horizontal position between the elongated arm and the support, the second coupling providing pivotal movement in a substantially vertical plane and configured to be rotated through a variety of orientations in a substantially horizontal plane.

2. The apparatus of claim 1, wherein the elongated member includes at least two orifices disposed proximate the ends, the orifices sized and configured to receive at least one end of the coupling.

3. The apparatus of claim 1, wherein an end of the coupling is received and movably secured within the orifice to form a pivot point allowing position and orientation of the device to be adjusted.

4. The apparatus of claim 3, wherein the end of the coupling is movably secured within the orifice by a connection assembly that attaches to the end of the coupling and frictionally engages an interior portion of the elongated member.

5. The apparatus of claim 1, wherein the couplings may be rotated at increments of fifteen (15) degrees.

6. The apparatus of claim 1, wherein the device is a light, a monitor, a liquid crystal display (LCD), delivery head, or a mirror.

7. The apparatus of claim 1, wherein couplings create a four-point pivot around the elongated member such that the support may be mounted to a surface above or below the device.

8. (canceled)

9. (canceled)

10. The apparatus of claim 7, wherein a portion of the coupling includes a plurality of openings that allow at least one fastener to be removably secured at various orientations.

11. The apparatus of claim 10, wherein the plurality of openings are spaced at fifteen (15) degree increments proximate the perimeter of the coupling.

12. The apparatus of claim 7, wherein the coupling and an orifice are configured to allow orientation of the apparatus in two directions.

13. The apparatus of claim 1, further comprising a bracket pivotally attached to another end the coupling, the bracket configured to receive and retain a portion of a device.

14. The apparatus of claim 1, wherein the coupling has a generally L-shaped or angled configuration forming an angle of about ninety (90) degrees.

15. A mechanical arm capable of being moved between various positions, comprising:
an elongated member including at least two connection points disposed on a single side and proximate each end;
a connection assembly comprising a biasing member and a securing member;
an elbow-shaped coupling including a first end and a second end, the first end movably attached to one of the at least two connection points by biasing the biasing member with the securing member;
a second connection assembly comprising a biasing member and a securing member; and
a second elbow-shaped coupling comprising a first end and a second end, the first end movably attached to another of the at least two connection points by biasing the biasing member with the securing member.

16. The mechanical arm of claim 15, further comprising:
a device movably attached to the second end of the coupling, the positioning of the device capable of being altered by rotation of the couplings; and p1 a support movably attached at one end to the second end of the another coupling and secured at a second end to a surface.

17. The mechanical arm of claim 16, wherein the coupling and the second coupling at least partially form a four-pivot linkage to allow adjustment of the mechanical arm.

18. The mechanical arm of claim 15, wherein the securing member is a fastener that may be detached to release the biasing member to allow the coupling to be rotated.

19. The mechanical arm of claim 18, wherein the securing member is configured for reattachment to secure the biasing member at different orientations.

20. The mechanical arm of claim 15, wherein the coupling and the second coupling have a shape that is at an angle of about ninety (90) degrees with respect to the elongated member.

21. A mechanical arm that is capable of being adjusted, comprising:
an elongated housing including a body and a cover, the body and cover configured to be assembled to form a hollow interior portion;
elbow-shaped couplings attached proximate the ends of the elongated housing, the couplings attached by connection assemblies within the hollow interior portion and providing pivotal movement in a substantially vertical plane; and
at least one fastener removably attaching the body to the cover.

22. The mechanical arm of claim 21, wherein the body includes an orifice disposed proximate each end.

23. The mechanical arm of claim 21, wherein the cover is configured for selective removal to access the hollow interior portion allowing adjustment of internal mechanisms.

24. The mechanical arm of claim 21, further including a gasket disposed between the body and the cover.

25. The mechanical arm of claim 21, wherein the elongated housing has generally curved or arched configuration.
